(19) United States
(12) Patent Application Publication
(10) Pub. No.: US 2012/0068697 A1
(43) Pub. Date: Mar. 22, 2012

(54) APPARATUS AND METHOD FOR DETECTING DEFECT USING MULTIPLE PHASE SELECTABLE PULSED EDDY CURRENT

(76) Inventors: Dong Man Suh, Daejeon City (KR); Seung Kee Chea, Daejeon City (KR); Dong Seob Suh, Daejeon City (KR); Min Seok Seo, Daejeon City (KR)

(21) Appl. No.: 12/597,966

(22) PCT Filed: Mar. 4, 2009
(86) PCT No.: PCT/KR09/01084

§ 371 Date: Nov. 17, 2011

(30) Foreign Application Priority Data
Oct. 7, 2008 (KR) 10-2008-0098207

(51) Int. Cl. G01N 27/90

(52) U.S. Cl. 324/238

(57) ABSTRACT

There is provided a apparatus and method for detecting defect using multiple phase selectable pulsed eddy current (PEC), comprising: an object to be determined as to presence of a defect; a PEC irradiation unit positioned close to a surface of the object, that irradiates a PEC signal to the object and receives a defect or defect-free signal reflected from the object as a result of irradiation; a measurement unit connected to the PEC irradiation unit by a cable, being input with the reflected PEC signal received in the PEC irradiation unit, and stored with a program for time-sharing and displaying the PEC signal on a graph, that processes a resultant value to be displayed; a display unit connected to the measurement unit, that displays the resultant value being output from the measurement unit; and an input unit connected to the measurement unit, that sets a phase (a multiple phase selectable value through selecting an arbitrary location by time-sharing the measured PEC signal), frequency (a frequency value of the input PEC signal) and gain (a time axis range of the reflected PEC signal) of the PEC signal irradiated to the object.

### TECHNICAL FIELD

The present invention relates to an apparatus and method for detecting defect using multiple phase selectable pulsed eddy current (PEC) and, more particularly, to a defect measurement apparatus using a multiple phase selectable PEC, comprising: an object to be determined as to presence of a defect; a PEC irradiation unit positioned close to a surface of the object, that irradiates a PEC signal to the object and receives a defect or defect-free signal reflected from the object as a result of irradiation; a measurement unit connected to the PEC irradiation unit by a cable, being input with the reflected PEC signal received in the PEC irradiation unit, and stored with a program for time-sharing and displaying the PEC signal on a graph, that processes a resultant value to be displayed; a display unit connected to the measurement unit, that displays the resultant value being output from the measurement unit; and an input unit connected to the measurement unit, that sets a phase (a multiple phase selectable value through selecting an arbitrary location by time-sharing the measured PEC signal), frequency (a frequency value of the input PEC signal) and gain (a time axis range of the reflected PEC signal) of the PEC signal irradiated to the object.

### BACKGROUND ART

Generally, in an apparatus for inspecting a defect of an object by using a pulsed eddy current (PEC) signal, the PEC signal is irradiated to the object and a measurement unit measures a slight difference between a voltage of a defective area and a voltage of a non-defective area so as to be visually confirmed. Accordingly, the apparatus is capable of determining whether the object has a defect based on the voltage difference.

However, since a conventional apparatus for inspecting a defect of an object is incapable of sensing any changes depending on a thickness of the object, the conventional apparatus merely determines that the object has a defect. Moreover, when an air gap is formed between the object and the measurement unit, measurement of a defect of the object is impossible.

Moreover, since the measurement is possible only within a range of a predetermined depth from the surface of the object, the conventional apparatus is incapable of measuring a defect generated beyond the predetermined depth.

### DISCLOSURE OF INVENTION

### TECHNICAL PROBLEM

Therefore, the present invention has been made to solve the above problems, and it is an aspect of the present invention to provide an apparatus and method for detecting defect using multiple phase selectable pulsed eddy current (PEC) and a defect measurement method using the same, in which a PEC irradiation unit for irradiating a PEC signal is positioned close to a measurement unit for measuring a defect of an object, and the measurement unit measures the PEC signal reflected back to the measurement unit, divides the PEC signal measured in time-sharing way, selects two arbitrary measurement values of the divided PEC signal so as to be used as coordinates on a graph and measures presence of defect based on a resultant value shown on the graph.

### TECHNICAL SOLUTION

In accordance with the present invention, the above and other aspects can be accomplished by an apparatus and method for detecting defect using multiple phase selectable pulsed eddy current (PEC), comprising: an object to be determined as to presence of a defect; a PEC irradiation unit positioned close to a surface of the object, that irradiates a PEC signal to the object and receives a defect or defect-free signal reflected from the object as a result of irradiation; a measurement unit connected to the PEC irradiation unit by a cable, being input with the reflected PEC signal received in the PEC irradiation unit, and stored with a program for time-sharing and displaying the input PEC signal on a graph, that processes a resultant value to be displayed; a display unit connected to the measurement unit, that displays the resultant value being output from the measurement unit; and an input unit connected to the measurement unit, that sets a phase (a multiple phase selectable value through selecting an arbitrary location by time-sharing the measured PEC signal), frequency (a frequency value of the input PEC signal) and gain (a time axis range of the reflected PEC signal) of the PEC signal irradiated to the object.

### ADVANTAGEOUS EFFECTS

In an apparatus and method for detecting defect using multiple phase selectable pulsed eddy current according to the present invention, a PEC irradiation unit for irradiating a PEC signal is positioned close to a measurement unit for measuring a defect of an object, and the measurement unit measures the PEC signal reflected back to the measurement unit, divides the PEC signal measured in time-sharing way, selects two arbitrary measurement values of the divided PEC signal so as to be used as coordinates on a graph, and measures presence of a defect of the object based on a resultant value shown on the graph. Therefore, the present invention has an effect of detecting an accurate position of a defect and a position where a defect is generated.

Furthermore, the apparatus for detecting defect using multiple phase selectable pulsed eddy current according to the present invention has another effect of enabling to measure a defect even though an air gap or any other objects exist between the PEC irradiation unit and the object.

### BRIEF DESCRIPTION OF DRAWINGS

These and other aspects and advantages of the present invention will become apparent and more readily appreciated from the following description of the embodiments, taken in conjunction with the accompanying drawings, in which:

FIG. 1 is a whole block diagram illustrating an apparatus for detecting defect using multiple phase selectable pulsed eddy current (PEC) according to the present invention;

FIG. 2 is a flow chart illustrating a method for detecting defect using multiple-phase selectable pulsed eddy current PEC according to the present invention;

FIG. 3 is a graph illustrating a PEC signal through time sharing the PEC signal, in the apparatus and method for detecting defect using multiple phase selectable pulsed eddy current according to the present invention;

FIG. 4 is a graph illustrating changes in impedance depending on a measured location, in the apparatus and method for detecting defect using multiple phase selectable pulsed eddy current according to the present invention;

FIG. 5 is a graph illustrating changes in impedance depending on a thickness of an object, in the apparatus and method for detecting defect using multiple phase selectable pulsed eddy current according to the present invention;

FIG. 6 is a graph illustrating an impedance difference between a notch and a step block, in the apparatus and method for detecting defect using multiple phase selectable pulsed eddy current according to the present invention;

FIG. 7 is a graph illustrating changes depending on a location of the object, in the apparatus and method for detecting defect using multiple phase selectable pulsed eddy current according to the present invention; and

FIG. 8 is a graph illustrating detection around a welding point, in the apparatus and method for detecting defect using multiple phase selectable pulsed eddy current according to the present invention.

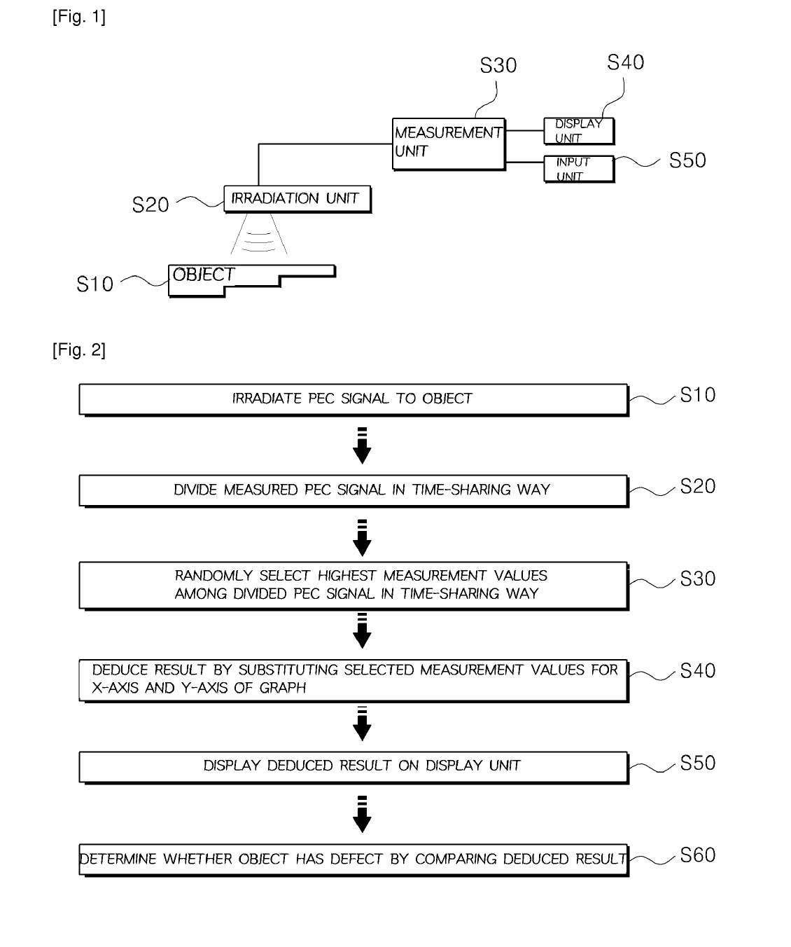

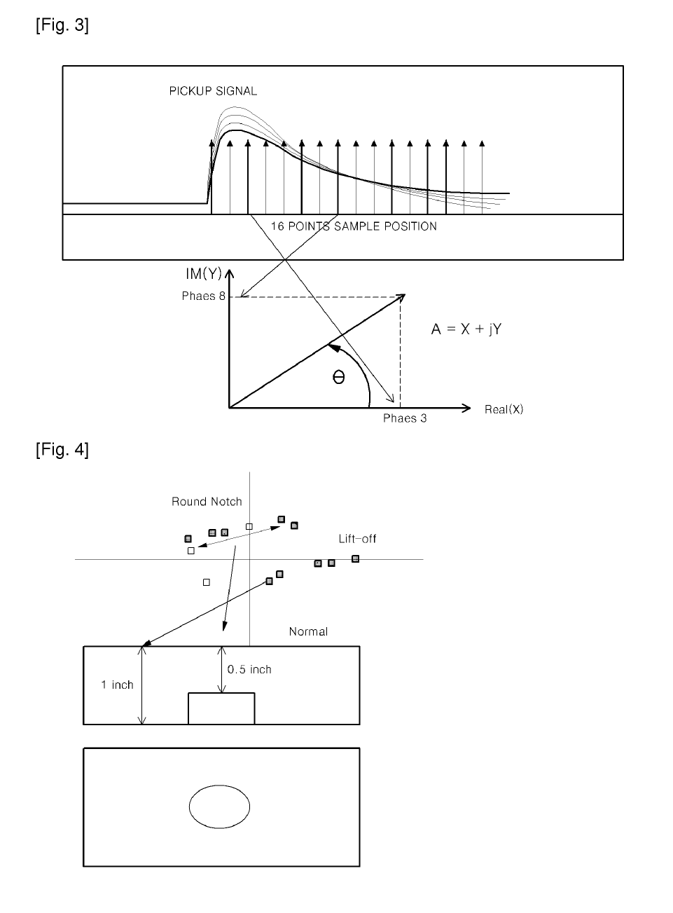

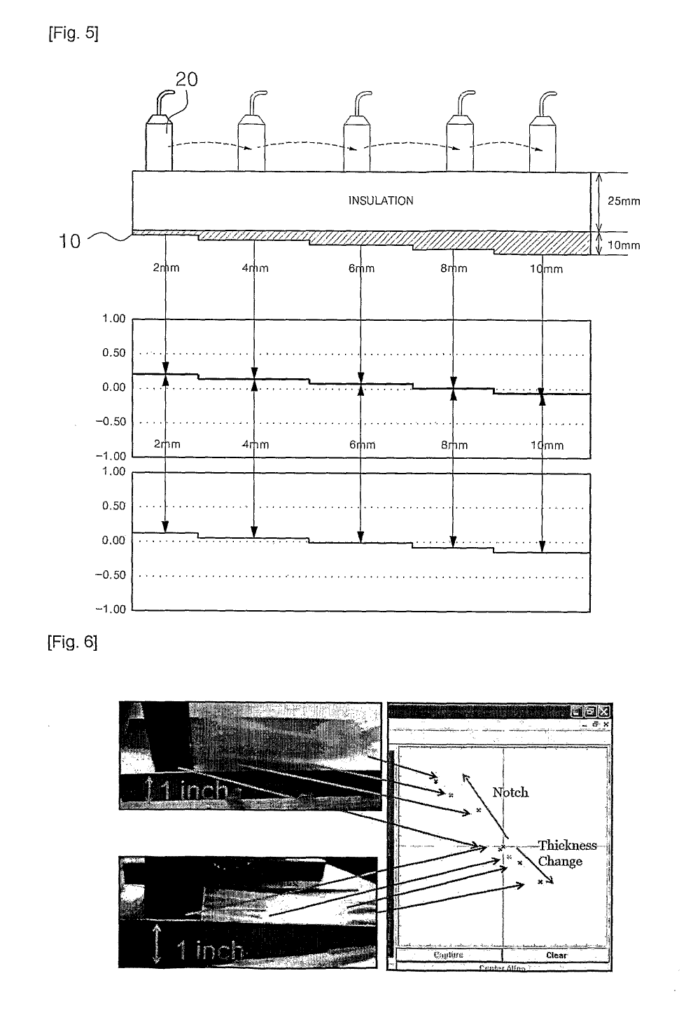

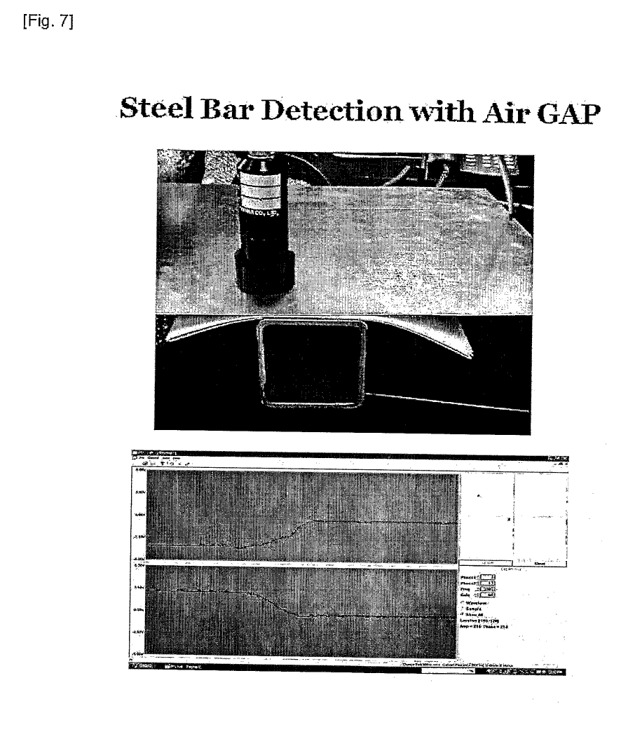

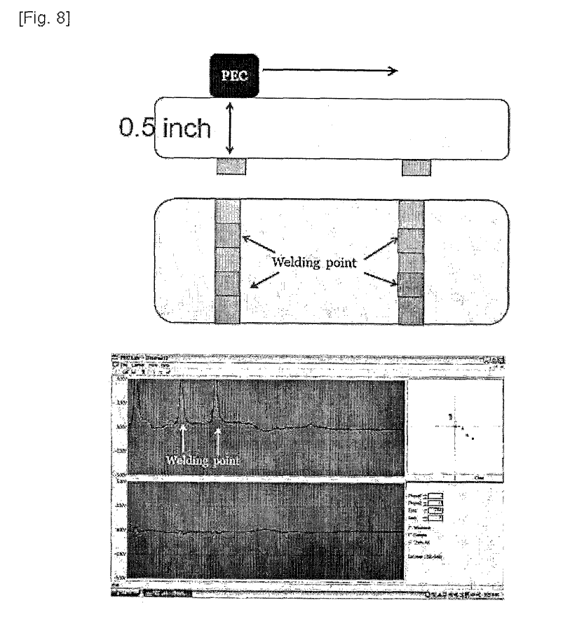

### BRIEF DESCRIPTION OF REFERENCE NUMBERS OF MAJOR ELEMENTS

10: object 20: PEC irradiation unit
30: measurement unit 40: display unit
50: input unit

### Mode for the Invention

Hereinafter, embodiments of the present invention will be described in detail with reference to the accompanying drawings.

As used herein, the singular forms “a”, “an” and “the” are intended to include the plural forms as well, unless the context clearly indicates otherwise.

An apparatus for detecting defect using multiple phase selectable pulsed eddy current (PEC) according to an aspect of the present invention comprises: an object 10 to be determined as to presence of a defect; a PEC irradiation unit 20 positioned close to a surface of the object 10, that irradiates a PEC signal to the object 10 and receives a defect or defect-free signal reflected from the object 10 as a result of irradiation; a measurement unit 30 connected to the PEC irradiation unit 20 by a cable, being input with the reflected PEC signal received in the PEC irradiation unit 20, and stored with a program for time-sharing and displaying the input PEC signal on a graph, that processes a resultant value to be displayed; a display unit 40 connected to the measurement unit 30, that displays the resultant value being output from the measurement unit 30; and an input unit 50 connected to the measurement unit 30, that sets a phase (a multiple phase selectable value through selecting an arbitrary location by time sharing the measured PEC signal), frequency (a frequency value of the input PEC signal) and gain (a time axis range of the reflected PEC signal) of the PEC signal irradiated to the object 10.

The measurement unit 30 displays all differences in impedance depending on thicknesses and defects of the object 10 in one graph on the display unit 40.

A defect measurement method using a defect measurement apparatus using a pulsed eddy current (PEC) according to another aspect of the present invention comprises: an irradiation step S10 of irradiating a PEC signal to an object 10 by using a PEC irradiation unit 20; a time-sharing step S20 of dividing the PEC signal measured by the PEC irradiation unit 20 in time sharing way by using a program stored in a measurement unit 30 connected to the PEC irradiation unit 20; a selection step S30 of automatically selecting two measurement values having high output values among the PEC signal divided in time sharing way in the measurement unit 30, by using the program stored in the measurement unit 30; a result deduction step S40 of substituting the two measurement values selected at the selection step S30 for an X-axis value and a Y-axis value of a graph, respectively, and deducing a resultant value of a point at which the two measurement values meet each other; a display step S50 of displaying the resultant value deduced at the result deduction step S40 on a display unit 40; and a defect determination step S60 of moving the PEC irradiation unit 20 for measurement, displaying the measurement values of a number of points measured by the measurement unit 30 by repeating the irradiation step S10, the time-sharing step S20, the selection step S30, the result deduction step S40 and the display step S50 to display each of the points on the graph shown on a screen of the display unit 40, comparing the resultant values in the graph changed from a zero (‘0’) point of the graph, detecting a location corresponding to a defect of the object 10 and determining as to presence of a defect of the object 10.

Three measurement values may be selected at the selection step S30 to deduce a resultant value on a three-dimensional graph at the result deduction step S40 and to be displayed as a three-dimensional graph at the display step S50.

The defect of the object (10) is measurable through using the PEC signal reflected from the object (10) by irradiating the PEC signal in the PEC irradiation unit (20) even though an air gap or any other objects are inserted between the PEC irradiation unit 20 and the object 10.As the PEC irradiation unit 20 moves, the measurement values displayed in the defect determination step S60 are displayed as a number of points varied in a horizontal direction, and a signal around a defective area has a greater voltage, compared to a normal area.

That is, the present invention will be described in more detail with reference to an embodiment below:

In accordance with a apparatus for detecting defect using multiple phase selectable pulsed eddy current (PEC), a PEC irradiation unit 20 is positioned close to a surface of an object 10 to be subject to defect detection and irradiates a PEC signal to the surface of the object 10. When the PEC signal irradiated from the PEC irradiation unit 20 is reflected from the object 10 and received by the PEC irradiation unit 20, an measurement unit 30 connected to the PEC irradiation unit 20 processes the PEC signal and displays a resultant value on a display unit 40 connected to the measurement unit 30. An input unit 50 connected to the measurement unit 30 sets a phase (a multiple phase selectable value through selecting an arbitrary location by time-sharing the measured PEC signal), frequency (a frequency value of the input PEC signal) and gain (a time axis range of the reflected PEC signal) of the PEC signal irradiated to the object 10.

In accordance with a method for detecting defect using multiple phase selectable pulsed eddy current PEC, a PEC signal is irradiated to an object 10 by a PEC irradiation unit 20, the PEC signal measured(received) by the PEC irradiation unit 20 is divided in time sharing way by a program stored in a measurement unit 30 connected to the PEC irradiation unit 20, two measurement values having high output values are automatically selected from the PEC divided in time-sharing way by the program stored in the measurement unit 30, the selected two measurement values are substituted for an X-axis value and an Y-axis value of a graph, respectively, to deduce a resultant value of a point where the two values meet each other, and the deduced resultant value is displayed on a display unit 40.

Furthermore, the PEC irradiation unit 20 is moved to measure a defect of the object 10, and the measurement values of a number of points measured by the measurement unit 30 by repeating the aforementioned steps are displayed to indicate each point in a graph on a screen of a display unit 40, so that a position of a defect of the object 10 is detected and whether the object 10 has a defect is determined by comparing the resultant values of the graph varied from a zero (“0”) point of the graph.

At this time, the defect of the object (10) is measurable through using the PEC signal reflected from the object (10) by irradiating the PEC signal in the PEC irradiation unit (20) even though an air gap or any other objects are inserted between the PEC irradiation unit 20 and the object 10. The measurement values displayed on the display unit 40 are displayed as a number of points varied in the horizontal direction as the PEC irradiation unit 20 is moved. The signal around a defective area is indicated as having a greater voltage, compared to a normal area.

Among the PEC signals divided in time-sharing way by the measurement unit 30, three measurement values may be selected to deduce a resultant value on a three-dimensional graph, so that the display unit 40 displays the resultant value as a three-dimensional graph.

1. An apparatus for detecting defect using multiple phase selectable pulsed eddy current (PEC) comprising:
an object (10) to be determined as to presence of a defect;
a PEC irradiation unit (20) positioned close to a surface of the object (10), that irradiates a PEC signal to the object (10) and, as a result, receives a defect or defect-free signal reflected from the object (10);
a measurement unit (30) connected to the PEC irradiation unit (20) by a cable, being input with the reflected PEC signal received in the PEC irradiation unit (20), and stored with a program for time-sharing and displaying the PEC signal on a graph, that processes a resultant value to be displayed;
a display unit (40) connected to the measurement unit (30), that displays the resultant value being output from the measurement unit (30); and
an input unit (50) connected to the measurement unit (30), that sets a phase (a multiple phase selectable value through selecting an arbitrary location by time-sharing the measured PEC signal), frequency (a frequency value of the input PEC signal) and gain (a time axis range of the reflected PEC signal) of the PEC signal irradiated to the object (10).

2. The apparatus for detecting defect using multiple phase selectable pulsed eddy current according to claim 1, wherein the measurement unit (30) displays all differences in impedance depending on thicknesses and defects of the object (10) in one graph shown on the display unit (40).

3. A method for detecting defect using multiple phase selectable pulsed eddy current (PEC), the method comprising:
an irradiation step (S10) of irradiating a PEC signal to an object (10) by using a PEC irradiation unit (20);
a time-sharing step (S20) of dividing the PEC signal measured in the PEC irradiation unit (20) in time sharing way by using a program stored in a measurement unit (30) connected to the PEC irradiation unit (20);
a selection step (S30) of automatically selecting two measurement values having high output values among the PEC signal divided in time sharing way in the measurement unit (30), by using the program stored in the measurement unit (30);
a result deduction step (S40) of substituting the two measurement values selected at the selection step (S30) for an X-axis value and a Y-axis value of a graph, respectively, and deducing a resultant value of a point at which the two measurement values meet each other;
a display step (S50) of displaying the resultant value deduced at the result deduction step (S40) on a display unit (40); and
a defect determination step (S60) of moving the PEC irradiation unit (20) for measurement, displaying the measurement values of a number of points measured by the measurement unit (30) by repeating the irradiation step (S10), the time-sharing step (S20), the selection step (S30), the result deduction step (S40) and the display step (S50) to display each of the points on the graph shown on a screen of the display unit (40), comparing the resultant values in the graph changed from a zero (‘0’) point of the graph, detecting a position corresponding to a defect of the object (10) and determining as to presence of a defect of the object (10).

4. The method for detecting defect using multiple phase selectable pulsed eddy current according to claim 3, wherein three measurement values are selected at the selection step (S30) to deduce a resultant value for a three-dimensional graph at the result deduction step (S40), and to be displayed as a three-dimensional graph at the display step (S50).

5. The method for detecting defect using multiple phase selectable pulsed eddy current according to claim 3, wherein, the defect of the object(10) is measurable through using the PEC signal reflected from the object (10) by irradiating the PEC signal in the PEC irradiation unit (20)), even though an air gap or any other objects are inserted between the PEC irradiation unit (20) and the object (10).

6. The method for detecting defect using multiple phase selectable pulsed eddy current according to claim 3, wherein, as the PEC irradiation unit (20) moves, the measurement values displayed at the defect determination step (S60) are displayed as a number of points varied in a horizontal direction and the signal around a defective area is indicated as having a greater voltage, compared to a normal area.
